(19) United States
(12) Patent Application Publication
(10) Pub. No.: US 2012/0153129 A1
(43) Pub. Date: Jun. 21, 2012

(54) IMAGING APPARATUS

(75) Inventor: Takanobu Sato, Kofu (JP)

(73) Assignee: Pioneer Corporation, Kawasaki-shi, Kanagawa (JP)

(21) Appl. No.: 13/383,052

(22) PCT Filed: Jul. 15, 2009
(86) PCT No.: PCT/JP2009/062825

§ 371 Date: Mar. 8, 2012

(51) Int. Cl. H01J 31/38

(52) U.S. Cl. 250/208.1

(57) ABSTRACT

An imaging apparatus which can provide a uniform magnetic field distribution in an image pickup device and can be reduced in size includes an electron emission source array with a plurality of electron emission sources arranged on a plane perpendicular to an optical axis, and a translucent substrate having an optoelectronic film disposed on the optical axis to be opposed to the electron emission source array with a space therebetween. The imaging apparatus has a magnet portion for forming in the space a magnetic field in a direction orthogonal to each principal plane of the translucent substrate and the electron emission source array. The magnet portion includes a plurality of magnets which are disposed in parallel to the optical axis so that the respective magnetic poles thereof are arranged in a forward direction in parallel to the optical axis and will not contact with each other.

### TECHNICAL FIELD

The present invention relates to a photoconductive image pickup device which has an electron emission source array with a plurality of electron emission sources arranged on a plane, and an optoelectronic film opposed thereto. More particularly, the invention relates to an imaging apparatus which employs such an image pickup device and a magnetic field converging structure.

### BACKGROUND ART

Electron emission source arrays with a plurality of minute electron emission sources disposed in a matrix on a substrate plane and configured to draw out electrons by applying an electric field thereto have been known as cold cathodes.

Such electron emission sources which are each drivable at a low voltage and simplified in structure have been studied for application to compact imaging devices which employ an electron emission source array.

For example, in the field of imaging devices, studies have also been conducted on such imaging devices that have a combination of the image pickup device with an electron emission source array and the magnetic field converging structure. It has been reported that electron beams can be converged by forming magnetic force lines in a direction perpendicular to the plane of the electron emission source array (in parallel to the direction of travel of electron beams from the electron emission sources). (See Patent Literature 1.)

An imaging device combined with the conventional magnetic field converging structure, an image pickup device is disposed at the center of the hollow of a cylindrical magnet to form a magnetic field in parallel to the direction of electron emission from the electron emission source of the image pickup device. Furthermore, Patent Literature 1 suggests an imaging device which has, in addition to the cylindrical magnet surrounding the image pickup device, a disc-shaped permanent magnet disposed behind the image pickup device to be opposed to the image pickup device.

Using the hollow of the conventional cylindrical magnet requires a cylindrical magnet with an increased cylinder length and an increased cylinder diameter in order to form a magnetic field in parallel to the direction of electron emission within the range of the effective light-receiving area of the optoelectronic film.

### CITATION LIST

### Patent Literature

PTL 1: Japanese Patent Kokai No. 2005-322581

### SUMMARY OF INVENTION

### Technical Problem

In this context, the inventor has repeated experiments to reduce the size of the imaging device. As a result, it has been found that reducing the inner diameter of the cylindrical magnet having the magnetic field converging structure which is disposed around the conventional image pickup device would provide a nonuniform magnetic field strength and thus such a size reduction would be difficult to achieve.

For example, FIG. 1 shows a magnetic field distribution (strength) provided by simulation when a cylindrical magnet 511 around an image pickup device 821 and a disc magnet 521 behind the image pickup device are used. The conventional structure shows that the magnetic force line within the dotted line region in which the image pickup device is located is not perpendicular to the electron emission source array but distorted. As shown in FIG. 2, it can be seen that the magnetic force lines (the arrows) within the region of the image pickup device 821 which is indicated with a dotted line at the center of the figure is misaligned with the vertical direction of the optoelectronic film. When electron beams emitted from the electron emission source array are converged under this condition, the difference in the degree of convergence between the center and the outer circumference of the electron emission source array would cause variations in images, thus raising the problem with making the product commercially available as an imaging device. Furthermore, the magnetic force lines in the vicinity of the image pickup device are not perpendicular to the electron emission source array but distorted, causing an increase in leakage of magnetic fields out of the magnet. This also raises the problem with making the product commercially available as an imaging device.

In this context, by way of example, the present invention offers an imaging apparatus which provides a uniform magnetic field distribution in the image pickup device having a magnetic field converging structure and which contributes to reduction in the size of the apparatus by solving a conventional problem that a uniform magnetic field could not be obtained without increasing the inner diameter of the magnet.

### Solution to Problem

The imaging apparatus of the present invention includes an electron emission source array with a plurality of electron emission sources arranged on a plane perpendicular to an optical axis, and a translucent substrate having an optoelectronic film opposed on the optical axis to the electron emission source array with a space therebetween. The imaging apparatus emits electrons to the optoelectronic film by dot sequential scanning across the electron emission sources for output as an electrical signal associated with an optical image which has been projected onto the optoelectronic film by the incidence of light through the translucent substrate. The imaging apparatus includes a magnet portion for forming in the space a magnetic field in a direction orthogonal to each principal plane of the translucent substrate and the electron emission source array. The magnet portion includes a plurality of magnets which are disposed in parallel to the optical axis in a manner such that the respective magnetic poles thereof are arranged in a forward direction in parallel to the optical axis and are not in contact with each other.

In the aforementioned imaging apparatus, the plurality of magnets of the magnet portion can each define a hollow along the symmetric axis thereof, and can be a plurality of cylindrical permanent magnets which accommodate the translucent substrate and the electron emission source array at the center of the hollow and which are aligned coaxially with the optical axis.

In the aforementioned imaging apparatus, the plurality of magnets of the magnet portion can be provided with a gap or nonmagnetic material between mutually adjacent magnets.

In the aforementioned imaging apparatus, the gap or the nonmagnetic material can be disposed closer to the light incident side than to the optoelectronic film.

In the aforementioned imaging apparatus, the plurality of magnets of the magnet portion each can have a different coercivity.

In the aforementioned imaging apparatus, the plurality of magnets of the magnet portion each can have a different magnet inner diameter.

In the aforementioned imaging apparatus, the plurality of magnets of the magnet portion each can have a different magnet outer diameter.

In the aforementioned imaging apparatus, the plurality of magnets of the magnet portion each can have a different magnet thickness.

The aforementioned imaging apparatus can have a second magnet portion. The second magnet portion can be a disc-shaped second permanent magnet which is disposed on the optical axis opposite to the light incident side with a space from the electron emission source array and is opposed to the electron emission source array so that the symmetric axis is coaxial with the optical axis.

In the aforementioned imaging apparatus, the second permanent magnet can have an opening which is coaxial with the optical axis.

### Advantageous Effects of Invention

The image pickup device according to the present invention includes the optoelectronic film; the electron emission source array with a plurality of electron emission sources disposed in an array; a plurality of magnets disposed around the image pickup device to converge an electron beam emitted from the electron emission source array; and another magnet disposed behind the image pickup device. The plurality of magnets are disposed around the image pickup device to converge an electron beam.

Thus, the present invention can provide a uniform magnetic field distribution in the image pickup device, thereby allowing for solving the problem that a uniform magnetic field could not have been conventionally obtained without increasing the inner diameter of the magnets, and achieving a compact imaging apparatus which employs the electron emission source array.

### BRIEF DESCRIPTION OF DRAWINGS

FIG. 1 is a diagram illustrating a magnetic field distribution around an image pickup device provided by simulation when a cylindrical magnet around the image pickup device and a disc magnet behind the image pickup device are used.

FIG. 2 is a diagram illustrating magnetic force lines around an image pickup device when a cylindrical magnet around the image pickup device and a disc magnet behind the image pickup device are used.

FIG. 3 is a cross-sectional view illustrating a cylindrical image pickup device in an imaging apparatus according to an embodiment of the present invention.

FIG. 4 is a block diagram illustrating the configuration of an electron emission source array chip and a controller for controlling the entire apparatus in an image pickup device of an imaging apparatus according to an embodiment of the present invention, the array chip having an electron emission source array and circuits for driving the same.

FIG. 5 is an explanatory view illustrating the structure of an active drive electron emission source array according to an embodiment of the present invention, schematically showing the electron emission source portion in an enlarged partial cross-sectional view.

FIG. 6 is a schematic cross-sectional view illustrating the configuration of an image pickup device and the surrounding thereof in an imaging apparatus according to an embodiment of the present invention.

FIG. 7 is a partially cutaway perspective view schematically illustrating the configuration of an image pickup device and the surrounding thereof in an imaging apparatus in an imaging apparatus according to an embodiment of the present invention.

FIG. 8 is a diagram illustrating a magnetic field distribution around an image pickup device in an imaging apparatus according to an embodiment of the present invention provided by simulation when a cylindrical magnet around the image pickup device and a disc magnet behind the image pickup device are used.

FIG. 9 is a diagram illustrating a magnetic force line around an image pickup device in an imaging apparatus according to an embodiment of the present invention provided when a cylindrical magnet around the image pickup device and a disc magnet behind the image pickup device are used.

FIG. 10 is a schematic cross-sectional view illustrating the configuration of an image pickup device and the surrounding thereof in an imaging apparatus according to another embodiment of the present invention.

FIG. 11 is a schematic cross-sectional view illustrating the configuration of an image pickup device and the surrounding thereof in an imaging apparatus according to another embodiment of the present invention.

FIG. 12 is a schematic cross-sectional view illustrating the configuration of an image pickup device and the surrounding thereof in an imaging apparatus according to another embodiment of the present invention.

FIG. 13 is a schematic cross-sectional view illustrating the configuration of an image pickup device and the surrounding thereof in an imaging apparatus according to another embodiment of the present invention.

FIG. 14 is a schematic cross-sectional view illustrating the configuration of an image pickup device and the surrounding thereof in an imaging apparatus according to another embodiment of the present invention.

FIG. 15 is a schematic front view illustrating how an optoelectronic film of the image pickup device is viewed from the light incident side in the imaging apparatus according to an embodiment of the present invention.

### REFERENCE SIGNS LIST

4 vacuum space
5 magnet portion
5b second magnet portion
10 image pickup device
11 optoelectronic film
12 electrically conductive translucent film
13 translucent substrate
15 mesh electrode
20 electron emission source array
22 Y scanning driver
23 X scanning driver
24 electron emission source array chip
25 support
26 controller
30 device substrate
31 electron emission source
33 lower electrode
34 electron supply layer
35 insulator layer
36 upper electrode
36a bridge portion
37 carbon layer
77 device separation film
74 gate insulating film
75 gate electrode
72 source electrode
76 drain electrode
70 interlayer insulating film
71 contact hole
80 enlarged opening space
91 electron emission portion

### DESCRIPTION OF EMBODIMENTS

Now, an imaging apparatus according to the embodiments of the present invention will be explained below with reference to the drawings. It is to be understood that the embodiments will be illustrated only by way of example and the present invention will not be limited thereto.

Image Pickup Device of Imaging Apparatus

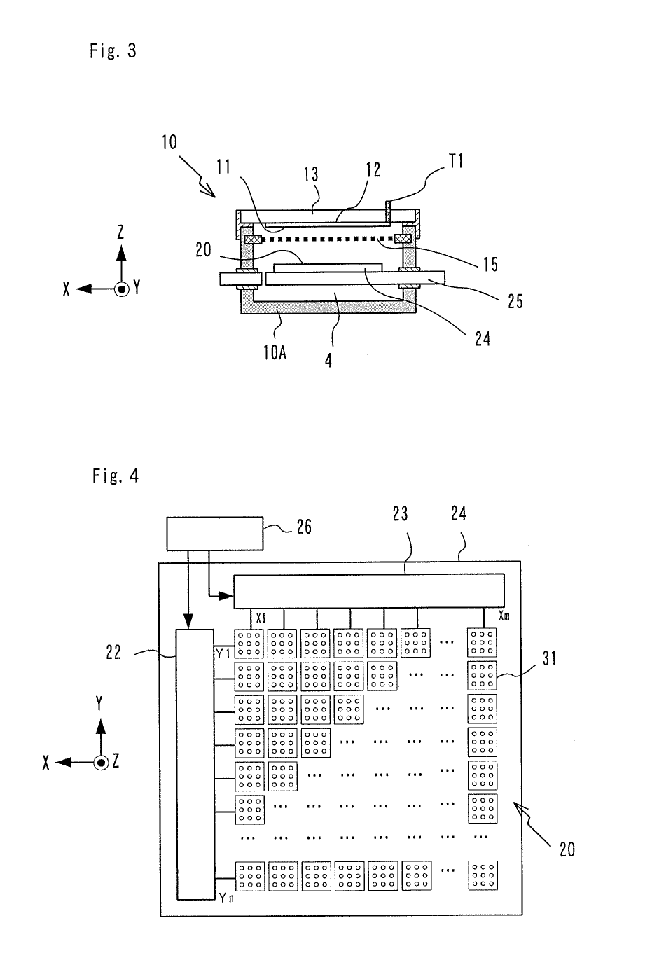

With reference to FIGS. 3, 4, and 5, a description will be made to an example of an image pickup device in an imaging apparatus. The image pickup device includes an electron emission source array 20 with a plurality of electron emission sources arranged on a plane (XY plane) perpendicular to an optical axis (Z direction), and a translucent substrate 13 with an optoelectronic film 11 opposed on the optical axis to the electron emission source array 20 with a space therebetween. The image pickup device is configured to emit electrons to the optoelectronic film 11 by dot sequential scanning across the electron emission sources for output as an electrical signal associated with an optical image which has been projected onto the optoelectronic film 11 by the incidence of light through the translucent substrate 13.

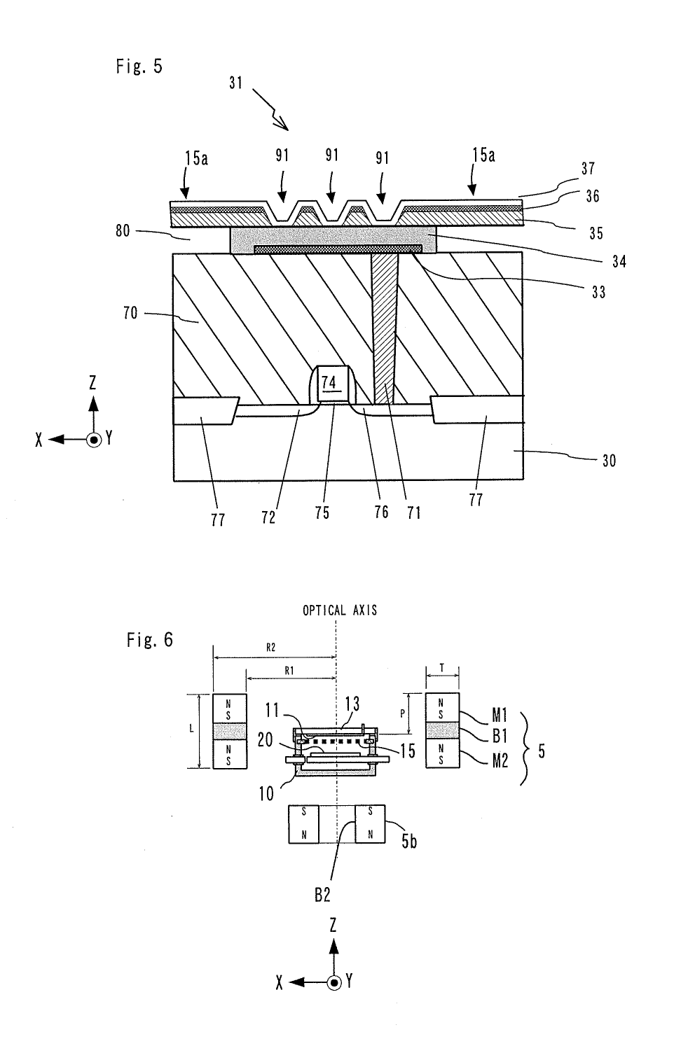

FIG. 3 is a cross-sectional view illustrating the image pickup device 10 which is cylindrical. FIG. 4 is a block diagram illustrating the configuration of an electron emission source array chip 24 of the image pickup device 10 and a controller 26 for controlling the entire device, the array chip including the electron emission source array 20, and a Y scanning driver 22 and a X scanning driver 23 which drive the electron emission source array. FIG. 5 is an enlarged partial cross-sectional view schematically illustrating an electron emission source 31 portion of the electron emission source array chip under magnification to explain an active drive electron emission source array, the electron emission source being formed on a silicon device substrate 30.

In the image pickup device 10 shown in FIG. 3, the optoelectronic film 11 facing an inner space of a vacuum 4 is formed on an electrically conductive translucent film 12, and the electrically conductive translucent film 12 is formed in advance on the translucent substrate 13 made of glass or the like.

The optoelectronic film 11 is a light-receiving section for receiving light from an object to be imaged, and is mainly formed of amorphous selenium (Se), but may also be formed of another material, for example, a compound semiconductor such as silicon (Si), lead oxide (PbO), cadmium selenide (CdSe), or gallium arsenide (GaAs).

The electrically conductive translucent film 12 can be formed, for example, of tin oxide (SnO₂), ITO (indium tin oxide), or Se—As—Te. As will be described later, the electrically conductive translucent film 12 is supplied with a predetermined positive voltage via a connection terminal T1 provided on the translucent substrate 13.

The translucent substrate 13 has only to be formed of a material which transmits the light of wavelengths at which the image pickup device 10 picks up images. For example, to pick up images by visible light, the substrate 13 is made of a material such as glass that transmits visible light, whereas to pick up images by ultraviolet light, the substrate 13 is made of a material such as sapphire or silica glass that transmits ultraviolet light. Furthermore, to pick up images by X-ray, the substrate 13 may only have to be made of a material, such as beryllium (Be), silicon (Si), boron nitride (BN), or aluminum oxide (Al₂O₃), which transmits X-ray.

On the electrically conductive translucent film 12 side of the optoelectronic film 11, there is provided a hole injection stopping layer such as of CeO₂ for preventing holes in the electrically conductive translucent film 12 from being injected into the optoelectronic film 11. Furthermore, on the vacuum space side, there can be provided an electron injection device layer such as of Sb₂S₃ for preventing electrons from being injected into the optoelectronic film 11.

A mesh electrode 15 in the vacuum space is provided with a plurality of penetrating openings and is made of, for example, a well-known metal material, an alloy, or a semiconductor material. The mesh electrode 15 is supplied with a predetermined positive voltage via a connection terminal (not shown). The mesh electrode is an intermediate electrode which is provided for accelerating electrons and collecting excessive electrons. This makes it possible to improve the directivity of electron beams and thereby provide an improved resolution.

As will be described in more detail later, the electron emission source array chip 24 is configured such that the gate electrode of a metal oxide semiconductor (MOS) transistor for driving the electron emission sources is connected to an X scanning driver (horizontal scanning circuit) and the source electrode is connected to a Y scanning driver 22 (vertical scanning circuit) to perform the dot sequential scanning. The Y scanning driver and the X scanning driver are formed on the electron emission source array chip 24 on one chip integrally with the electron emission source array, and provided on a support 25 in a glass housing 10A. The signals and voltages that are required to drive the electron emission source array chip 24 are supplied through the connection terminal (not shown) that is provided in the glass housing 10A.

The electron emission source array chip 24 and the translucent substrate 13 are disposed generally in parallel to each other with the vacuum space 4 therebetween and is vacuum-sealed in the translucent substrate 13 and the glass housing 10A which are sealed with frit glass or indium metal.

As shown in FIG. 4, the plurality of the electron emission sources 31 are arranged in a matrix on the substrate plane (XY plane) to form the electron emission source array 20. The electron emission source array 20 and the Y scanning driver 22 and the X scanning driver 23 for driving the same are formed on one chip as the electron emission source array chip 24. Note that the controller 26 and other circuits to be discussed later may also be provided on the chip.

The electron emission source array 20 formed on the upper surface of the chip is constructed as an integrated active drive electric field emitter array (FEA) which has the electron emission source array directly stacked in layers on a driving circuit LSI which is formed on a Si wafer. The electron emission source array 20 can cope with a high-speed driving (for example, a driving pulse width of several tens of nano seconds for one electron emission source 31) of an image pickup operation for dot sequential scanning. The electron emission source array 20 is formed of a plurality of electron emission sources 31 which are arranged in a matrix of n rows and m columns (the number of pixels is n×m) and which are connected to n and m scanning driving lines (hereafter referred to as the scanning line) in the Y direction (the vertical direction) and the X direction (the horizontal direction), respectively.

Furthermore, the number of the electron emission sources 31 of the electron emission source array 20 is, for example, 1920×1080, with the size of one electron emission source 31 being 20×20 μm². The surface portion of one electron emission source 31 is provided with an electron emission portion 91 which is an opening for emitting electrons. For example, on the area of 8×8 μm² of one electron emission source 31, there are formed 3×3 electron emission portions 91 (1 μmφ) with the electron emission source having a diameter of about 1 μm. For example, one electron emission portion 91 emits an electron flow of several microamperes (μA) (with an emission current density of about 4 A/cm²). Note that the numerical values in this embodiment are shown only by way of example, and as well applicable by being modified or changed as appropriate depending on the apparatus for which the image pickup device is used, the resolution of the image pickup device, sensitivity thereof or the like.

The Y scanning driver 22 and the X scanning driver 23 perform the dot sequential scanning and drive the electron emission sources 31 on the basis of control signals from the controller 26 such as a vertical sync signal (V-Sync), a horizontal sync signal (H-Sync), and a clock signal (CLK). That is, the scanning lines (Yj, j=1, 2, . . . , n) are sequentially scanned in the Y direction, so that when one scanning line (let the line be Yk) is selected, the scanning lines (Xi, i=1, 2, . . . , m) are sequentially scanned in the X direction to selectively drive each electron emission source 31 on that scanning line (Yk), thereby performing the dot sequential scanning. Then, the electron emission source 31 is switched to emit electrons by controlling, with the scanning lines, the drain potential of the MOS transistor, that is, the potential of the lower electrode of each electron emission source 31 of the electron emission sources 31.

FIG. 5 is an explanatory view illustrating the electron emission source 31 in the electron emission source array to be subjected to active driving and the MOS transistor for switching the same, with the portion of the electron emission source 31 of the electron emission source array chip 24 (of FIG. 4) being enlarged. The electron emission source 31 of the electron emission source array formed on the silicon device substrate 30 is formed in a manner such that after the driving circuits of the MOS transistor arrays and the Y scanning driver and the X scanning driver for controlling and driving the same are formed on the device substrate 30, the electron emission source 31 is formed on top thereof.

Upper electrodes 36 are connected, for example, to the Y scanning driver to apply a predetermined signal to each thereof. Lower electrodes 33 are connected, for example, to the X scanning driver to apply a predetermined signal to each thereof in sync with a vertical scan pulse. Since the electron emission portion 91 is disposed at the intersection between the lower electrode 33 and the upper electrode 36, in the image pickup device of the embodiment the lower electrode and the upper electrode 36 sequentially drive the electron emission portions 91 to scan the proximal optoelectronic film region with emitted electrons, and then obtain an optoelectronically converted video signal from an image formed on the optoelectronic film.

As shown in FIG. 5, the electron emission source 31 is a metal insulator semiconductor (MIS) type electron emission source formed in a layered structure which includes the lower electrode 33, an electron supply layer 34, an insulator layer 35, the upper electrode 36 which is, for example, made of tungsten (W), and a carbon layer 37. The upper electrode 36 of the electron emission source array 20 is common to each line and divides the lower electrode 33 and the electron supply layer 34 to electrically separate the electron emission sources 31 from each other. A recessed portion 91 which penetrates the insulator layer 35 and the upper electrode 36 to the electron supply layer 34 is the electron emission portion.

For a plurality of MOSFETs, the silicon device substrate 30 has a device separation film 77 formed in the silicon device substrate 30. On the silicon device substrate 30 between the device separation films 77, there are formed a gate insulating film 74 and a gate electrode 75 of poly-silicon. Furthermore, with the gate electrode 75 and the device separation film 77 employed as a mask, impurities are added to the silicon device substrate 30 and then activated, thereby allowing a source electrode 72 and a drain electrode 76 to be formed in a self-aligned manner. The lower electrode 33 electrically communicates with the drain electrode 76 via metal such as tungsten in a contact hole 71 that penetrates an interlayer insulating film 70. The electron emission sources 31 are independently separated from each other for each lower electrode 33. On top of the lower electrode 33, sequentially stacked in layers are the electron supply layer 34, the insulator layer 35, and the upper electrode 36, and then the electron emission portion 91 is formed as a recessed portion and covered with the carbon layer 37. The electron emission sources 31 are separated from each other by an enlarged opening space 80 which is formed by removing the electron supply layer 34 through etching. Although like the lower electrodes 33, the electron supply layers 34 are independently separated from each other for each electron emission source 31, the upper electrode 36 has bridge portions 36a which are suspended in the space to electrically connect between the adjacent electron emission sources 31. The carbon layer 37 is deposited on the upper electrode 36 of the electron emission portion 91.

Configuration and Operation of Imaging Apparatus

Next, a description will be made to the operation of the imaging apparatus.

In the image pickup device 10 shown in FIG. 3, external light that is incident upon the optoelectronic film 11 through the translucent substrate 13 and the electrically conductive translucent film 12 causes electron-hole pairs to be produced inside the film near the electrically conductive translucent film 12 depending on the amount of incident light. The hole of the pair is accelerated by a strong electric field applied to the optoelectronic film 11 through the electrically conductive translucent film 12 so as to collide one after another with atoms constituting the optoelectronic film 11 to produce additional electron-hole pairs. As such, avalanche multiplied holes are accumulated on the side of the optoelectronic film 11 opposed to the electron emission source array 20 (the side opposite to the electrically conductive translucent film 12), allowing a hole pattern to be formed corresponding to the incident light image. The current produced when the hole pattern and the electron emitted from the electron emission source array 20 are combined is detected on the electrically conductive translucent film 12 as a video signal associated with the incident light image.

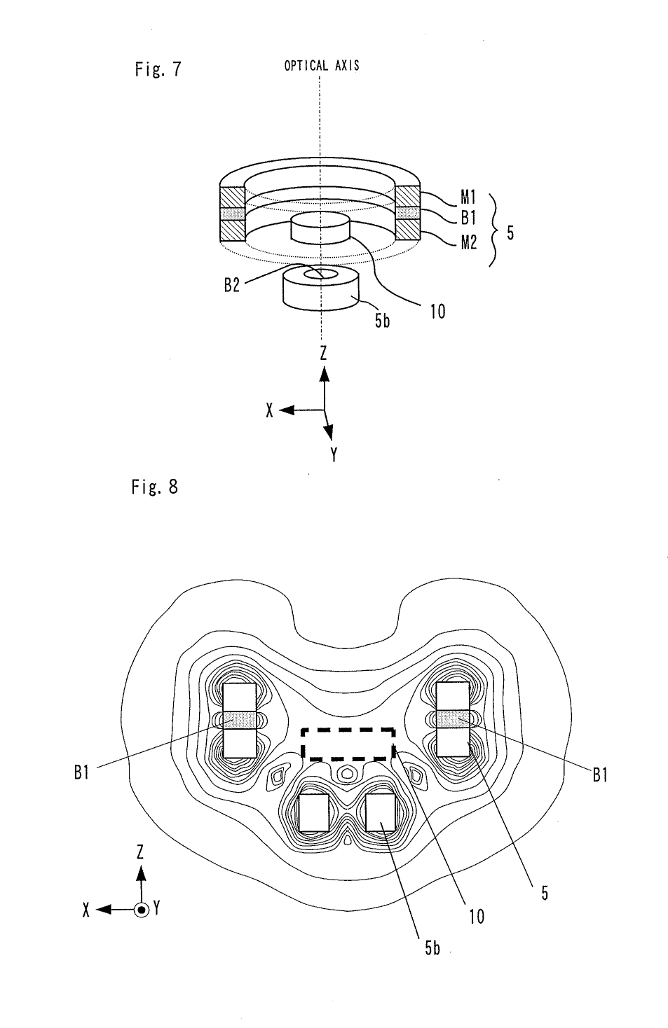

FIG. 6 is a cross-sectional view schematically illustrating the configuration of the image pickup device 10 and the surrounding thereof in the imaging apparatus. FIG. 7 is a partially cutaway perspective view schematically illustrating the configuration of the image pickup device 10 and the surrounding thereof in the imaging apparatus.

The imaging apparatus includes a cylindrical magnet portion 5 which surrounds the image pickup device 10 on the optical axis. The cylindrical magnet portion 5 which surrounds the image pickup device includes a plurality of annular permanent magnets (a light incident side annular magnet M1 and a substrate side annular magnet M2) and is disposed so that the magnetic force lines are aligned in parallel with

the optical axis. Furthermore, the light incident side annular magnet M1 and the substrate side annular magnet M2 are disposed so as to have the polarities aligned in the same direction. Furthermore, there is provided a cushioning portion B1 between the annular magnets M1 and M2. The cushioning portion B1 is a nonmagnetic material such as aluminum, brass, or resin, or a gap, and may be employed as a securing member for the light incident side annular magnet M1 and the substrate side annular magnet M2 if the cushioning portion B1 is a nonmagnetic material.

Furthermore, behind the image pickup device, there is provided an annular second magnet portion 5b of which polarity is opposite to that of the magnet portion 5 and which includes a cushioning portion B2. The second cushioning portion B2 is only a penetrating opening, but may also be a nonmagnetic material such as aluminum, brass, or resin which is filled in the opening. The second magnet portion 5b can be a disc-shaped second permanent magnet which is disposed on the optical axis opposite to the light incident side with a space from the electron emission source array 20 and is opposed to the electron emission source array 20 so that the symmetric axis is coaxial with the optical axis.

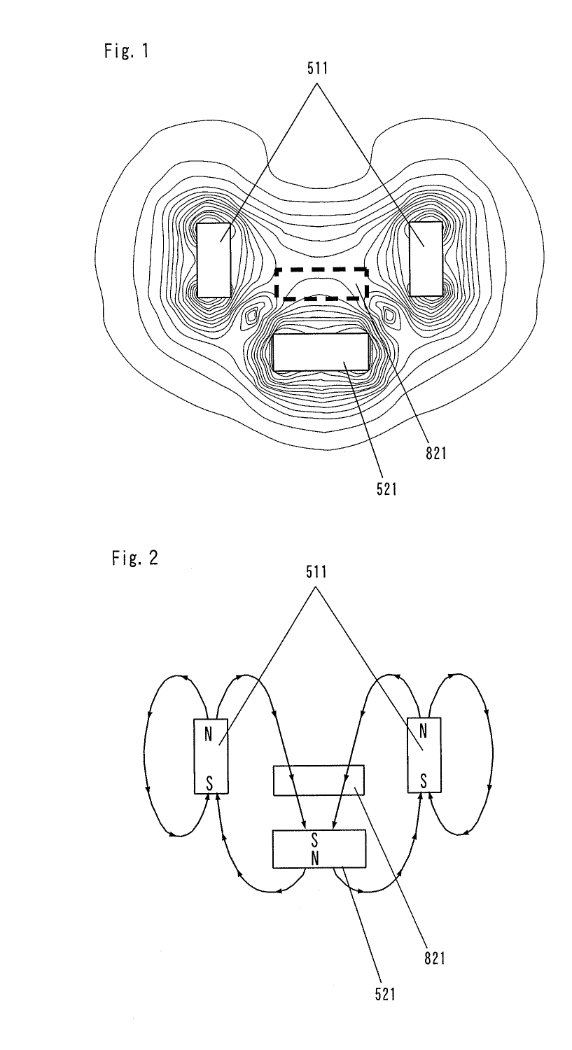

FIG. 8 shows a magnetic field distribution (strength) provided by simulation in an embodiment which employs the cylindrical magnet portion 5 having the aluminum cushioning portion B1 between the two annular magnets and the second disc magnet portion 5b having an opening behind the image pickup device 10. It can be seen that this embodiment provides a more uniform magnetic field strength than the conventional one shown in FIG. 1 in the box indicated by dotted lines in which the image pickup device 10 is placed, the box being located at a deeper position when viewed from the incident side of the aluminum cushioning portion B1 of the cylindrical magnet portion 5.

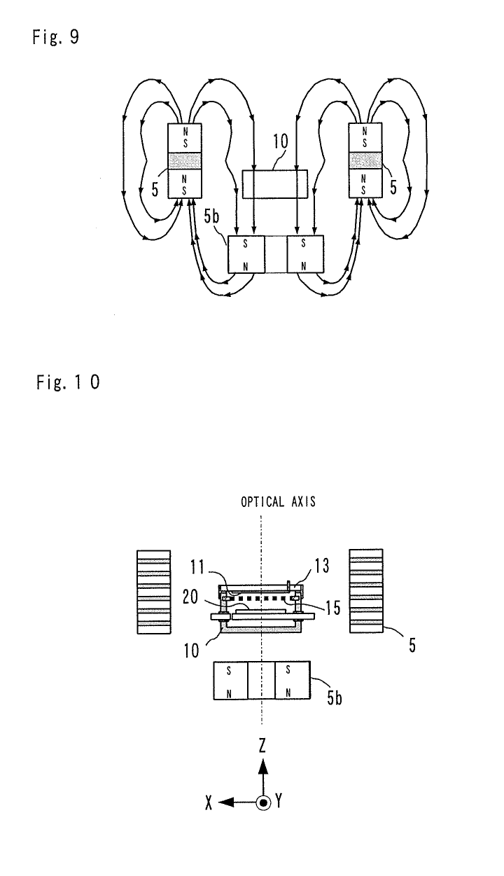

FIG. 9 shows the magnetic force lines around the image pickup device in the imaging apparatus of the embodiment shown in FIG. 8.

As shown in FIGS. 6 to 9, it can be seen that the magnet portion 5 having the cushioning portion B1 forms a magnetic field in a direction orthogonal to each principal plane of the translucent substrate 13 and the electron emission source array 20 in the space between the optoelectronic film 11 and the electron emission source array 20, that is, the magnetic force lines are aligned in the direction of the optical axis. As is obvious from FIGS. 6 to 9, it can be seen that the cushioning portion B1, i.e., the gap or the nonmagnetic material is disposed on the optical axis closer to the light incident side than to the optoelectronic film 11, thereby allowing the magnetic force lines to be aligned in the direction of the optical axis.

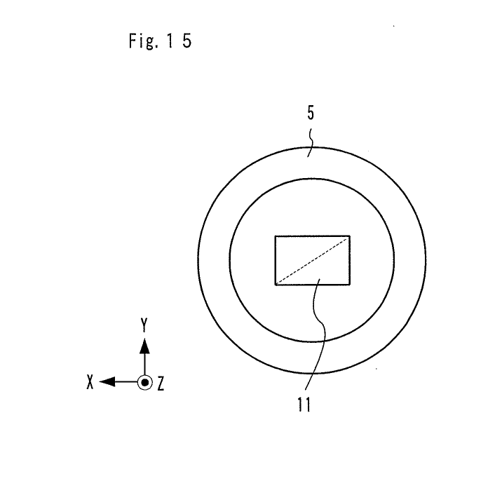

Furthermore, the preferred dimensions of the members of the imaging apparatus according to the embodiment should be as shown in FIG. 6 in order to obtain the similar distribution as that of FIG. 8. That is, the annular inner size (radius) R1 of the cylindrical magnet portion 5 is 10 to 35 mm; the annular outer size (radius) R2 is 20 to 40 mm; the annular length L of the cylindrical magnet portion 5 is 15 to 25 mm; the annular thickness T of the cylindrical magnet portion 5 is 5 to 10 mm; the annular position of the cushioning portion B1 is ½ the annular length; and the position p of the image pickup device (the position of the optoelectronic film 11) is 10 to 20 mm from the annular incidence end surface of the cylindrical magnet portion 5. Note that the image pickup device has a size of optical ½ inch (6.4 mm×4.8 mm) to optical one inch (12.7 mm×9.525 mm), and the magnet portion has a coercivity of 500 to 1500 kA/m. Note also that as shown in FIG. 15, the value in inch of the image pickup device size shows the length of the diagonal line (broken line) of the rectangular effective light-receiving surface of the optoelectronic film 11. As a result, when compared with the conventional magnet (FIG. 1), the magnet portion 5 of this embodiment has been reduced in size as a whole, i.e., achieving a reduction of 56/90 in inner diameter and a reduction of 340/488 in length in the direction of the optical axis.

In the imaging apparatus, such a space that has magnetic force lines perpendicular to the electron emission source array 20 is formed by a plurality of annular magnets M, thereby allowing the electron beams spread at an angle from the electron emission source array 20 to reach the optoelectronic film 11 while travelling in a spiral fashion around the magnetic force lines due to the Lorentz force. Note that the mesh electrode 15 interposed between the optoelectronic film 11 and the electron emission source array 20 is supplied with a voltage to adjust the speed of electrons, thereby allowing for controlling the diameter of the electron beams that arrive at the optoelectronic film 11. It is also possible to form a plurality of convergence points by the voltage across the mesh electrode 15.

As described above, according to the aforementioned imaging apparatus, the magnet portion 5 is provided with the cushioning portion B1, which is a gap or a nonmagnetic material, between the cylindrical light incident side annular magnet M1 and the cylindrical substrate side annular magnet M2. The image pickup device 10 is disposed near the center of the hollow of the magnet portion 5 to reduce the magnetic force near the middle portion between the two annular magnets and provide improved uniformity to the horizontal magnetic fields. The second magnet portion 5b is provided at the center thereof with a hole (the cushioning portion B2), thereby allowing the magnetic force lines in the vicinity of the image pickup device 10 to be parallel to a direction perpendicular to the electron emission source array.

As described above, in this embodiment the magnet portion 5 is provided with a plurality of magnets M which are disposed in parallel to the optical axis so that the respective magnetic poles thereof are arranged in a forward direction in parallel to the optical axis and are not in contact with each other. Furthermore, the plurality of magnets M of the magnet portion 5 each define a hollow along the symmetric axis thereof and are aligned coaxially with the optical axis so as to accommodate the translucent substrate and the electron emission source array at the center of the hollow.

The aforementioned configuration makes it possible to eliminate in-plane variations of the electron beams from the electron emission sources 31, direct the otherwise spreading magnetic force lines to the center of the hollow to provide uniform magnetic fields in the vicinity of the image pickup device 10 that is disposed near the center thereof, and converge the magnetic force lines so as to be perpendicular to the electron emission source array 20.

Imaging Apparatus of Other Embodiments

In the aforementioned embodiment, the magnet portion 5 was formed of the two annular magnets stacked one on the other with the magnetic poles aligned in the same direction. However, for example, as shown in FIG. 10, the magnet portion 5 can also be formed by stacking seven annular magnets M one on another with the magnetic poles aligned in the same direction. The same effects can be obtained when the respective magnetic poles of a number of annular magnets are directed in the forward direction parallel to the optical axis. The same effects can also be obtained by a plurality of annular magnets M and nonmagnetic materials B being alternately stacked in layers.

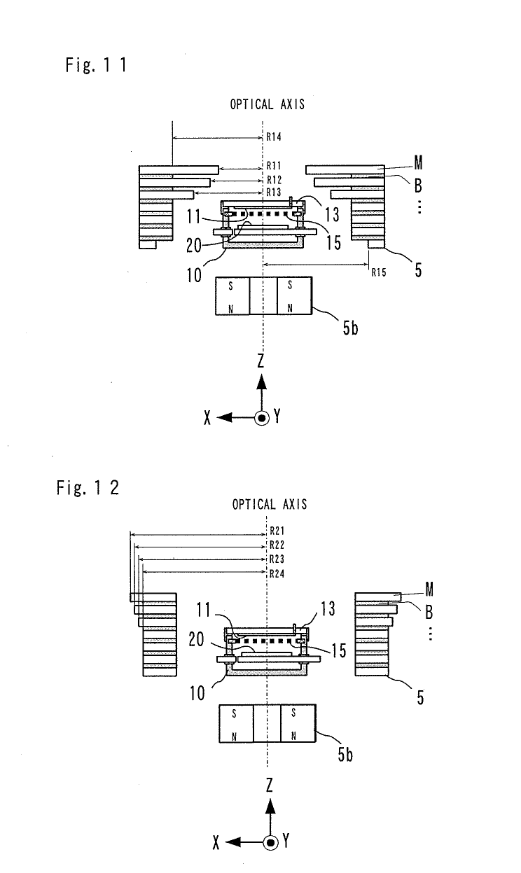

Furthermore, as shown in FIG. 11, in an imaging apparatus according to another embodiment, a plurality of annular magnets M, for example, seven annular magnets M of the magnet portion 5 (for example, each having a thickness of 2 mm in the direction of the optical axis) and the cushioning portion B (having a thickness of 1 mm in the direction of the optical axis) may be alternately stacked in layers so that the inner radii are different from each other (for example, letting R11, R12, R13, R14, and R15 be the inner radius of each annular magnet in order from the light incident side, so that R11=13 mm, R12=15 mm, R13=20 mm, R14=25 mm, and R15=30 mm).

Furthermore, as shown in FIG. 12, in an imaging apparatus according to another embodiment, for example, seven annular magnets M of the magnet portion 5 (for example, each having a thickness of 2 mm in the direction of the optical axis) and the cushioning portion B (having a thickness of 1 mm in the direction of the optical axis) may be alternately stacked in layers so that the outer radii are different from each other (for example, letting R21, R22, R23, and R24 be the inner radius of each annular magnet in order from the light incident side, so that R21=40 mm, R22=39 mm, R23=38 mm, and R24=37 mm).

Furthermore, as shown in FIG. 13, in an imaging apparatus according to another embodiment, a plurality of cylindrical annular magnets may be formed coaxially as one structure with the outer and inner radii varied. This also provides the same effects. That is, the magnet portion 5 can be formed in agreement with the shape of the electron emission source array.

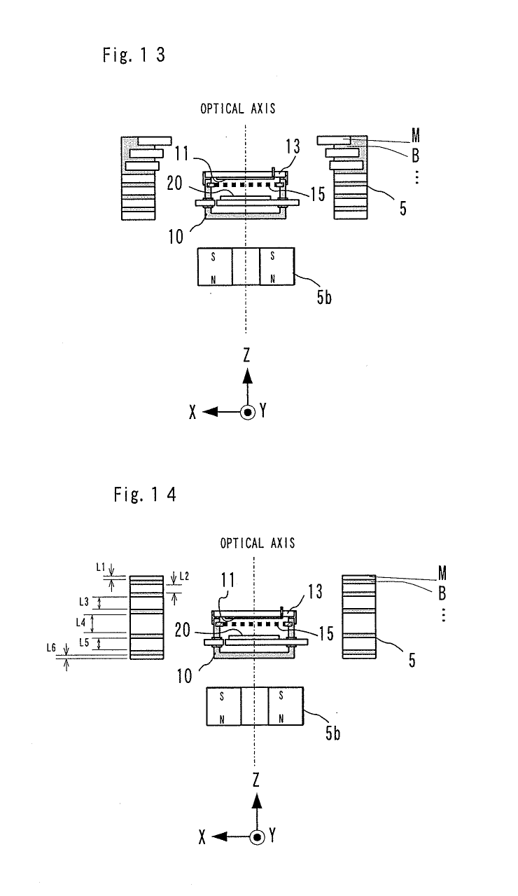

Furthermore, as shown in FIG. 14, in an imaging apparatus according to another embodiment, the thicknesses of the annular magnets M may be varied from the light incident side (for example, letting L1, L2, L3, L4, L5, and L6 be the thickness of the annular magnets in order from the light incident side, so that L1=1 mm, L2=2 mm, L3=3 mm, L4=4 mm, L5=3 mm, and L6=1 mm), and a plurality of annular magnets M and the nonmagnetic material B (having a thickness of 1 mm in the direction of the optical axis) may be alternately stacked in layers, thereby providing the same effects. That is, in an imaging apparatus according to another embodiment, the plurality of annular magnets of the magnet portion 5 may each have a different thickness.

Furthermore, the same effects can also be provided not only by varying the inner and outer shape of the magnets but also by disposing a variety of magnets having different magnetic force strengths. That is, in an imaging apparatus according to another embodiment, the plurality of annular magnets of the magnet portion 5 may each have a different coercivity.

In any of the aforementioned embodiments, the cylindrical magnet portion 5 around the image pickup device 10 is not limited to the cylindrical or disc shape, but may also have a rectangular or square cross-sectional shape depending on the image pickup area of the image pickup device 10, with the opening being also rectangular. This will also provide the same effects as those provided by the aforementioned embodiments. Furthermore, in any of the aforementioned embodiments, although not illustrated, the aforementioned imaging apparatus is equipped with a magnetic shielding mechanism for reducing magnetic field leakage to the surrounding.

In any of the aforementioned embodiments, the electron emission source array illustrated above has a plurality of electron emission portions disposed in a matrix with the recessed portions covered with a carbon layer, the recessed portions penetrating the insulator layer and the upper electrode down to the electron supply layer. However, the present invention is not limited thereto. The present invention is also applicable to the imaging apparatus which employs another planer type electron emission source array, such as, what is called, a Spindt electron emission source matrix array.

While the imaging apparatus according to the aforementioned embodiments has been described, the structure for improving the uniformity of magnetic fluxes in the electron travelling portion of the electron emission source array according to the present invention can also be applied to planer type display devices and rendering devices.

1. An imaging apparatus comprising an electron emission source array with a plurality of electron emission sources arranged on a plane perpendicular to an optical axis, and a translucent substrate having an optoelectronic film opposed on the optical axis to the electron emission source array with a space therebetween so that the imaging apparatus emits electrons to the optoelectronic film by dot sequential scanning across the electron emission sources for output as an electrical signal associated with an optical image which has been projected onto the optoelectronic film by the incidence of light through the translucent substrate,
the imaging apparatus further comprising a first magnet portion for forming in the space a magnetic field in a direction orthogonal to each principal plane of the translucent substrate and the electron emission source array, wherein
the first magnet portion includes a plurality of magnets which are disposed in parallel to the optical axis in a manner such that respective magnetic poles thereof are arranged in a forward direction in parallel to the optical axis and are not in contact with each other, and
the imaging apparatus further comprising a second magnet portion, the second magnet portion being a disc-shaped second permanent magnet which is disposed on the optical axis opposite to the light incident side with a space from the electron emission source array and opposed to the electron emission source array so that a symmetric axis is coaxial with the optical axis, and the second permanent magnet having an opening which is coaxial with the optical axis.

2. The imaging apparatus according to claim 1, wherein the plurality of magnets of the first magnet portion each define a hollow along a symmetric axis thereof, and are a plurality of cylindrical permanent magnets which accommodate the translucent substrate and the electron emission source array at the center of the hollow and which are aligned coaxially with the optical axis.

3. The imaging apparatus according to claim 2, wherein the plurality of magnets of the first magnet portion are provided with a gap or nonmagnetic material between mutually adjacent magnets.

4. The imaging apparatus according to claim 3, wherein the gap or the nonmagnetic material is disposed closer to the light incident side than to the optoelectronic film.

5. The imaging apparatus according to claim 2, wherein the plurality of magnets of the magnet portion each have a different coercivity.

6. The imaging apparatus according to claim 2, wherein the plurality of magnets of the first magnet portion each have a different magnet inner diameter.

7. The imaging apparatus according to claim 2, wherein the plurality of magnets of the first magnet portion each have a different magnet outer diameter.

8. The imaging apparatus according to claim 2, wherein the plurality of magnets of the first magnet portion each have a different magnet thickness.

9-10. (canceled)
